(19) United States
(12) Patent Application Publication
(10) Pub. No.: US 2002/0126762 A1
(43) Pub. Date: Sep. 12, 2002

(54) Moving-picture data reproducing system

(75) Inventor: Shigekazu Tanaka, Kanagawa (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/091,913

(22) Filed: Mar. 6, 2002

(30) Foreign Application Priority Data
Mar. 6, 2001 (JP) 2001-061434

(51) Int. Cl. H04B 1/66

(52) U.S. Cl. 375/240.25

(57) ABSTRACT

A moving-picture data reproducing system judges whether the user is qualified or unqualified and whether or not the picture data includes toll information as electronic watermark. If the picture data includes toll information and the user is unqualified, B-pictures are removed and preceding I- or P-pictures are delivered instead of the removed B-pictures. The reduced picture data has unsmooth motion and urges the user to subscribe the content service of moving-picture data.

### BACKGROUND OF THE INVENTION

(a) Field of the Invention

The present invention relates to a moving-picture data reproducing system and, more particularly, to a moving-picture data reproducing system, which is capable of preventing an illegal copy and allowing observation of the contents of the picture data. The present invention also relates to a method for reproducing moving-picture data.

(b) Description of the Related Art

Digital signal processing is now increasingly used for processing moving-picture data instead of the conventional analog signal processing technology. This is achieved by the development of the video signal compression technologies such as MPEG1 and MPEG2 as well as the development of higher performance of the digital signal processing system. In the digital signal processing, the moving-picture signals are converted into digital data, which are then subjected to signal compression, accumulation and processing.

The digital picture data has a better affinity with the computer system compared to analog picture signals, whereby the computer system has a higher processing efficiency with respect to the digital picture data due to high-speed access and storage thereof. In addition, since it is possible to remove the noise involved in the data transfer or data processing, the digital picture processing has an advantage in that degradation of the picture quality does not arise irrespective of iterative copying of the picture data.

On the other hand, there is a problem in the digital picture processing that the digital picture data is often subjected to infringement of copy right by a malicious user, such as illegal copying, unfair transfer or modification of the picture data, without involving degradation of the picture quality. It is attempted in the prior art to prevent such an infringement of copy right in the picture data reproducing system, by using an encryption scheme wherein the picture data is encrypted to limit the access to the digital data and allows only a legal user having a recovery key to access the encrypted picture data.

In the encryption scheme as described above, however, once the recovery key is stolen or decrypted, copying the digital picture data cannot be prevented any more. Another technique for preventing the infringement of copy right is proposed wherein electronic watermark data which cannot be visually recognized is inserted or distributed in the digital picture data. Such a technique is described in Patent Publication JP-A-10-155151, for example.

If the digital picture data are iteratively copied, the electronic watermark data, distributed in the original digital picture data, remain as their original data in the copied digital picture data and thus can be detected after the coping.

The electronic watermark data may be used in a content distribution system as toll information, which prevents illegal reproduction of the digital picture data. In this case, after the reproducing system for the digital picture data detects the electronic watermark data, the reproducing system informs the user of the toll information or stops the reproduction of the digital picture data, thereby preventing infringement of the copy right.

If a malicious user is notified of the toll information, the malicious user often disregards the toll information and infringes the copy right of the picture data.

On the other hand, if the reproducing system stops reproduction of the picture data, the user cannot recognize the contents of the original picture data unless the user subscribes to the content distribution system.

In this case, if a service provider, for example, wishes a number of users to subscribe to the content service by distributing the original picture data through a network to the user as a demonstration, the users cannot recognize the contents of the original picture data before the users subscribe to the content service. Thus, the users are not likely urged to subscribe to the content service, whereby the service provider cannot expect the increase of the opportunity for subscription by the users.

Patent Publication JP-A-2000-184177 describes a technique for reproduction of sample picture data obtained by removing a part of the original picture data. FIGS. 1A to 1D show the pictures obtained by the picture data processing system described in the publication.

FIG. 1A shows the original picture, whereas FIGS. 1B to 1D respectively show the sample pictures, each of which has a part of the original picture modified to have a lower brightness by modifying the original picture, the each part being different in the three pictures.

Although the three pictures shown in FIGS. 1B to 1D have lower commercial values when viewed as separate snapshots, the three pictures, consecutively distributed at a small time interval for demonstration, have a commercial value compatible to the original picture. This allows these three pictures to be used as sample data.

The sample pictures observed compatible to the original picture, however, does not urge the user to subscribe to the content service because the sample data is free of charge and have high picture quality, thereby failing to increase the opportunity for subscription by the users.

### SUMMARY OF THE INVENTION

In view of the above problem in the prior art, it is an object of the present invention to provide a moving-picture data reproducing system, which is capable of urging users to subscribe to the content service of moving-picture data to thereby increase the opportunity of subscription by the users.

It is another object of the present invention to provide a method for reproducing moving-picture data.

The present invention provides a moving-picture data reproducing system for reproducing compressed moving picture data including I-pictures, P-pictures and B-pictures, the reproducing system including: a toll judgement section for judging whether or not the compressed moving picture data includes toll information; a qualification judgement section for judging whether a user is qualified or unqualified for reproduction of the compressed picture data; and a decoder for decoding the I-pictures, P-pictures and B-pictures if it is judged that the compressed picture data do not include toll information or it is judged that the user is qualified, the decoder decoding I-pictures or I- and P-pictures without decoding the B- and P-pictures or without decoding the B-pictures if it is judged that the compressed data includes the toll information and that the user is unqualified.

The present invention also provides a method for reproducing compressed moving picture data including I-pictures, P-pictures and B-pictures, the method including the steps of: judging whether or not the compressed moving picture data includes toll information; judging whether a user is qualified or unqualified for reproduction of the compressed picture data; and decoding the I-pictures, P-pictures and B-pictures if it is judged that the compressed picture data do not include toll information or it is judged that the user is qualified, and decoding the I-pictures or the I- and P-pictures if it is judged that the compressed data includes the toll information and that the user is unqualified.

In accordance with the picture data reproducing system and the method of the present invention, the moving picture data reproduced by the reproducing system have unsmooth motions and yet allow the unqualified users to observe the contents of the moving pictures before subscription, thereby urging the users to subscribe to the contents service of the moving-picture data distribution.

The above and other objects, features and advantages of the present invention will be more apparent from the following description, referring to the accompanying drawings.

### BRIEF DESCRIPTION OF THE DRAWINGS

FIGS. 1A to 1D show pictures including original picture and modified pictures used in a conventional technique.

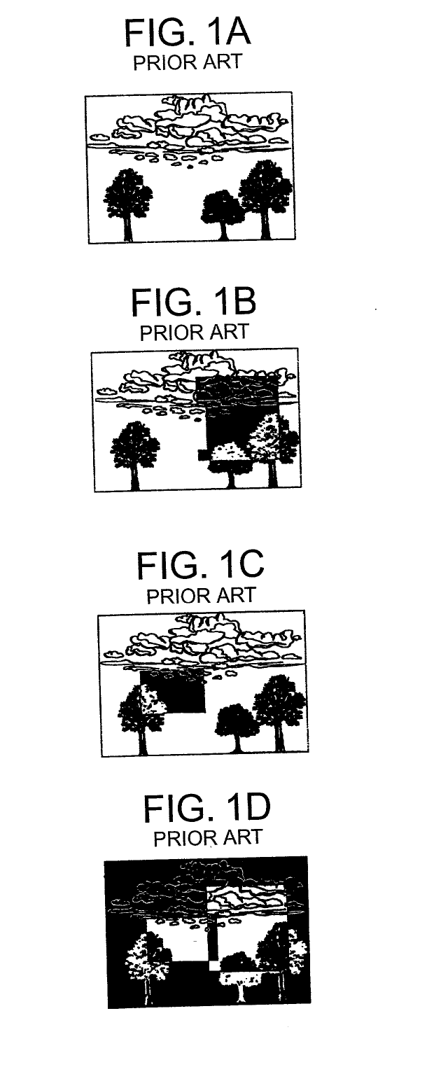

FIG. 2 is a block diagram of a moving-picture data reproducing system according to an embodiment of the present invention.

FIG. 3 is a logic diagram of the reduction judgement section shown in FIG. 2.

FIG. 4 is a table tabulating the types of data and users and contents observed by the users.

FIG. 5 is a block diagram of decoder shown in FIG. 2.

FIG. 6 is a flowchart of the normal picture display operation of the moving-picture data reproducing system of FIG. 2.

FIG. 7 is a diagram of data flows during the normal picture display operation shown in FIG. 6.

FIG. 8 is an example of flowchart of the reduced picture display operation of the moving-picture data reproducing system of FIG. 2.

FIG. 9 is a diagram of data flows during the reduced picture display operation shown in FIG. 8.

FIG. 10 is another example of flowchart of the reduced picture display operation of the moving-picture data reproducing system of FIG. 2.

FIG. 11 is a diagram of data flows during the reduced picture display operation shown in FIG. 10.

### PREFERRED EMBODIMENTS OF THE INVENTION

Now, the present invention is more specifically described with reference to accompanying drawings.

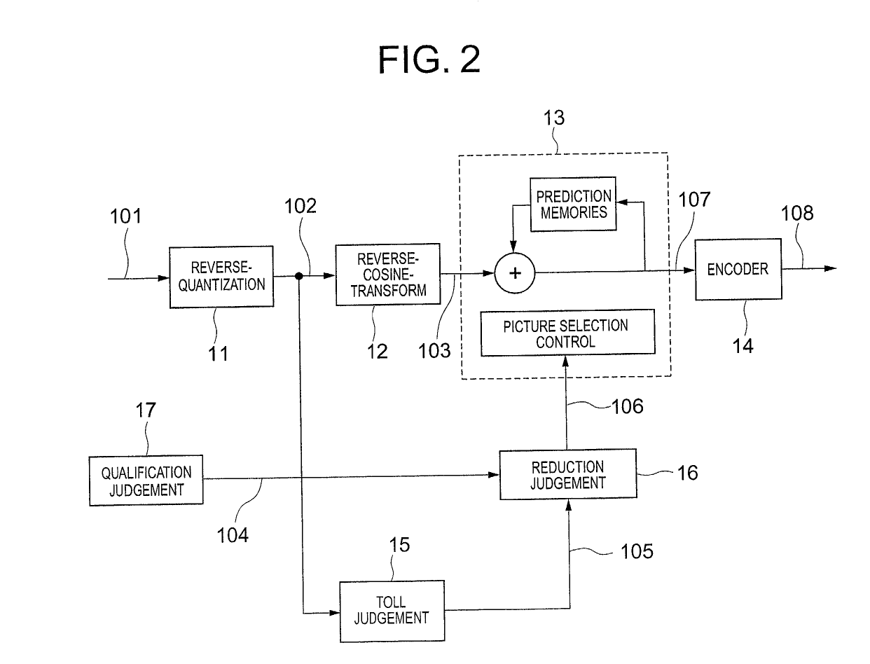

Referring to FIG. 2, a moving-picture data reproducing system, generally designated by numeral 10, according to an embodiment of the present invention includes a de-quantization section (reverse-quantization section) 11, a reverse-cosine-transform section 12, a decoder 13, an encoder 14, a toll judgement section 15, a reduction judgement section 16 and a qualification judgement section 17.

A picture data generating section (not shown) compresses moving-picture data by using a motion picture expert group (MPEG) format, to generate input picture data 101. The input picture data 101 are composed of three picture data each supplied in a frame to form an MPEG stream wherein electronic watermark data are distributed. The electronic watermark data have a specified pattern distribution which forms toll information. The electronic watermark data may have a plurality of other meanings.

The moving picture data reproducing system 10 communicates with the picture data generating section via a network to receive the input picture data 101. The input picture data 101 include the electronic watermark data as a noise component in the moving-picture data, which is not observed by human eyes and thus not affect the picture quality of the moving-picture data.

The reverse-quantization section 11 de-quantizes the input picture data 101 to generate a DCT (discrete-cosine-transformed) data 102, which are delivered to the reverse-cosine-transform section 12 and the toll judgement section 15.

The reverse-cosine-transform section 12 transforms the data expressed in the spatial-frequency area into the data expressed in the real-space area to generate reproduced data 103 from the DCT data 102, delivering the reproduced data 103 to the decoder 13.

The toll judgement section 15 scans the DCT data 102 to detect the electronic watermark data having the specific meaning. The toll judgement section 15 judges whether or not the electronic watermark data, if detected, represents toll information, such as indicating information of copy prohibition. The toll judgement section 15 then generates a toll judgement signal 105, which indicates that the picture data is charged, based on the judgement, and delivers the same to the reduction judgement section 16.

The qualification judgement section 17 judges whether or not the user of the reproducing system 10 is qualified for reproduction, generates a qualification signal 104 based on the judgment, and delivers the same to the reduction judgement section 16. The results of qualification judgement may include judgement of a regular qualification code by a normal user, judgement of a temporary qualification code applied to a guest user, and judgement of the unqualified user.

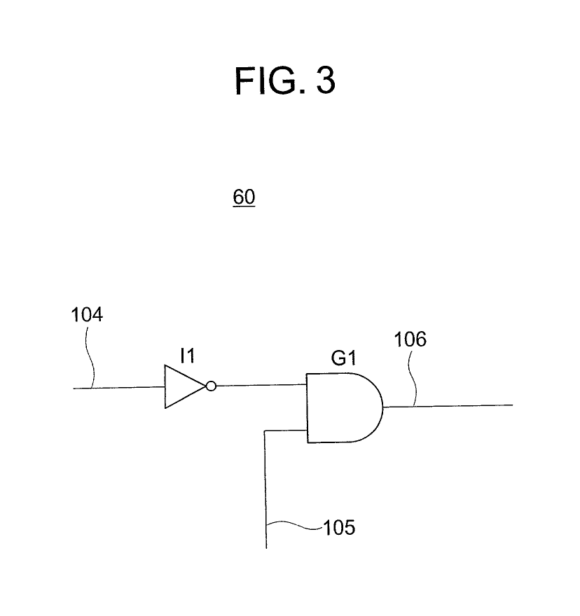

Referring to FIG. 3, the reduction judgement section 60 includes an inverter 11 for receiving the qualification signal 104 from the qualification judgement section 17, and an AND gate GI for receiving an output from the inverter II and the toll judgement signal 105 from the toll judgement section 15. The reduction judgement section 60 delivers the reduction control signal 106 to the encoder 13.

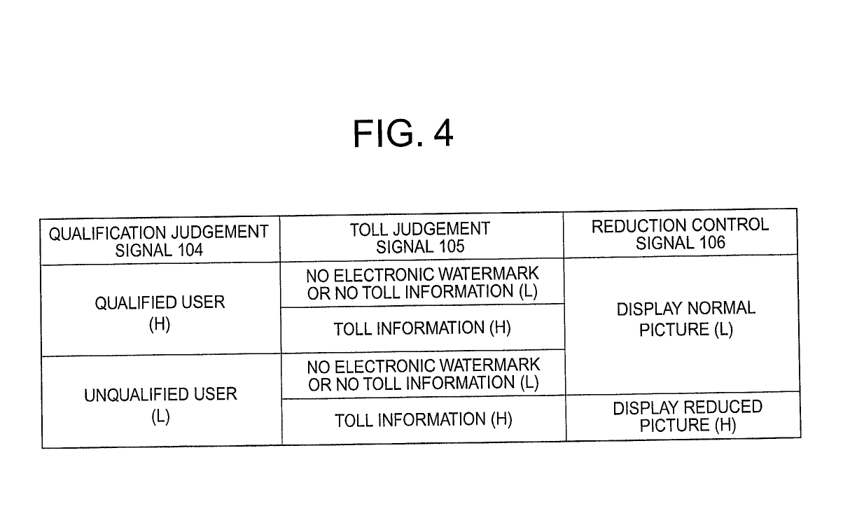

Referring to FIG. 4, there is shown a table tabulating the qualification judgement signal 104, toll judgement signal 105 and reduction control signal 106 which are generated by the qualification judgement section 17, toll judgement section 15 and reduction judgement section 16, respectively. The qualification judgement section 17 sets the qualification signal 104 at a high level if the user is qualified, and sets the qualification signal 104 at a low level if the user is unqualified.

The toll judgement section 15 sets the toll judgement signal 105 at a low level if the electronic watermark data is not detected or the toll information is not detected in the moving-picture data. The toll judgement section 15 sets the toll judgement signal 105 at a high level if the toll information is detected.

The reduction judgement section 16 sets the reduction control signal 106 at a high level if the user is unqualified and the toll information is detected, and otherwise, sets the reduction control signal 106 at a low level.

The decoder 13 decodes the reproduced data 103 to generate decoded data 107 based on addition using the prediction memories 18, delivering the decoded data 107 to the encoder 14 for display of the moving-picture data. In the decoding, the decoder 13 controls display of normal picture data or reduced picture data based on the reduction control signal 106.

The encoder 14 encodes the decoded data 107 to generate a display picture data 108 in the NTSC (National Television System Committee) data format or a PAL (Phase Alternation by Line) data format, delivering the same to a CRT etc.

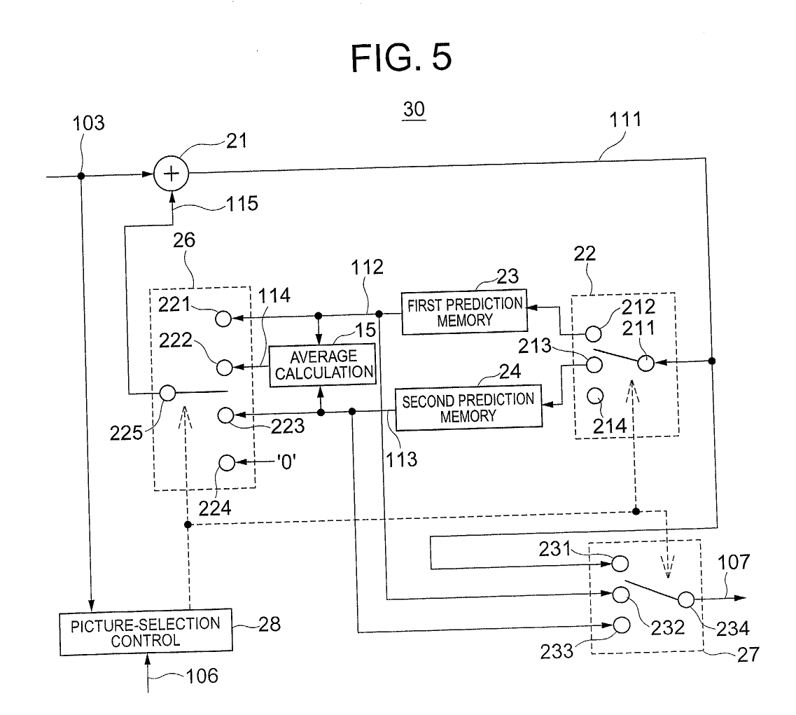

Referring to FIG. 5, the decoder 13 includes an adder 21, a first selector 22, a first prediction memory 23, a second prediction memory 24, an average calculation section 15, a second selector 26, a third selector 27, a picture type judgement section (or picture-selection control section) 28.

The picture-selection control section 28 distinguishes the picture type of the frame pictures in the reproduced data 103, then stores the write order of the pictures to be written in the prediction memories 23 and 24, and delivers selection control signals to the first through third selectors 22, 26 and 27.

The picture-selection control section 28 switches the data path for transferring the frame pictures on a picture-by-picture basis based on the reduction control signal 106, effects time prediction, and determines a normal picture display or a reduced picture display. The reduced picture display is such that some frame picture is omitted or removed and a preceding frame picture is displayed instead.

The technique for time prediction in the MPEG format will be described hereinafter for a better understanding of the present invention. In the MPEG format, both the data compression (spatial data-compression) in the spatial direction using a DCT technique and the data compression (time data-compression) in the time direction using a prediction technique are used. The time data-compression uses intra-frame encoding, wherein all the signals for specified picture data are encoded whereas differential signals for the picture data other than the specified data are encoded. The differential signals are obtained by calculating a difference between a preceding picture data and a succeeding picture data.

The time prediction technique includes preceding prediction, succeeding prediction and bi-directional prediction. The preceding prediction decodes the subsequent frame picture based on the succeeding frame picture, whereas the succeeding prediction decodes, based on the subsequent frame picture, the next subsequent frame picture following the subsequent frame picture. The bi-directional prediction uses the preceding prediction, the succeeding prediction or a combination of both the preceding and succeeding predictions for the decoding.

The MPEG format uses an intra-coded picture (I-picture), a predictive-coded picture (P-picture) and a bi-directionally predictive-coded picture (B-picture). The I-picture is obtained by intra-frame coding which directly generates the following picture data. The P-picture is obtained by prediction which generates the succeeding frame data based on the preceding I-picture or P-picture frame data. The B-picture is obtained by bi-directional prediction which calculates, for each pixel, averages of the preceding frame data and the succeeding frame data each including an I-picture and a P-picture.

The adder 21 adds the predictive data 115 input as an addend to the reproduced data 103 input as an augend, decoding the reproduced data 103 to generate sum data 111. The adder 21 delivers the sum data 111 to the input terminal 211 of the first selector 22 and the input terminal 231 of the third selector 27.

The first selector 22 has the single input terminal 211 and three output terminals 212 to 214, and has a switching function for coupling one of the three terminals to the input terminal 211 based on the selection control signal supplied from the picture-selection control section 28. The first selector 22 delivers the sum data 111 to the first prediction memory 23 or the second prediction memory 24 by coupling the output terminal 212 or 213 to the input terminal 211.

The first prediction memory 23 updates the first storage data 112 upon receiving the data from the first selector 22. The first prediction memory 23 delivers the first storage data 112 to the input terminal 232 of the third selector 27, the average calculation section 25 and the input terminal 221 of the second selector 26.

The second prediction memory 24 updates the second storage data 113 upon receiving the data from the first selector 22. The second prediction memory 24 delivers the second storage data 113 to the input terminal 233 of the third selector 27, the average calculation section 15 and the input terminal 223 of the second selector 26.

The average calculation section 25 calculates the average of the first storage data 112 and the second storage data 113, and delivers the average data 114 to the input terminal 222 of the second selector 26.

The second selector 26 has four input terminals 221 to 224 and a single output terminal 225, and has a switching function for coupling one of the four input terminals 221 to 224 and the output terminal 225 based on the selection control signal supplied from the picture-selection control section 28. The input terminal 224 receives “0”. The second selector 26 delivers the prediction data 115 to the adder 21.

The third selector 27 has three input terminals 231 to 233 and a single output terminal 234, and has a switching function for coupling one of the input terminals 231 to 233 to the output terminal 234. The third selector 26 delivers a decoded signal 107 to the encoder 14.

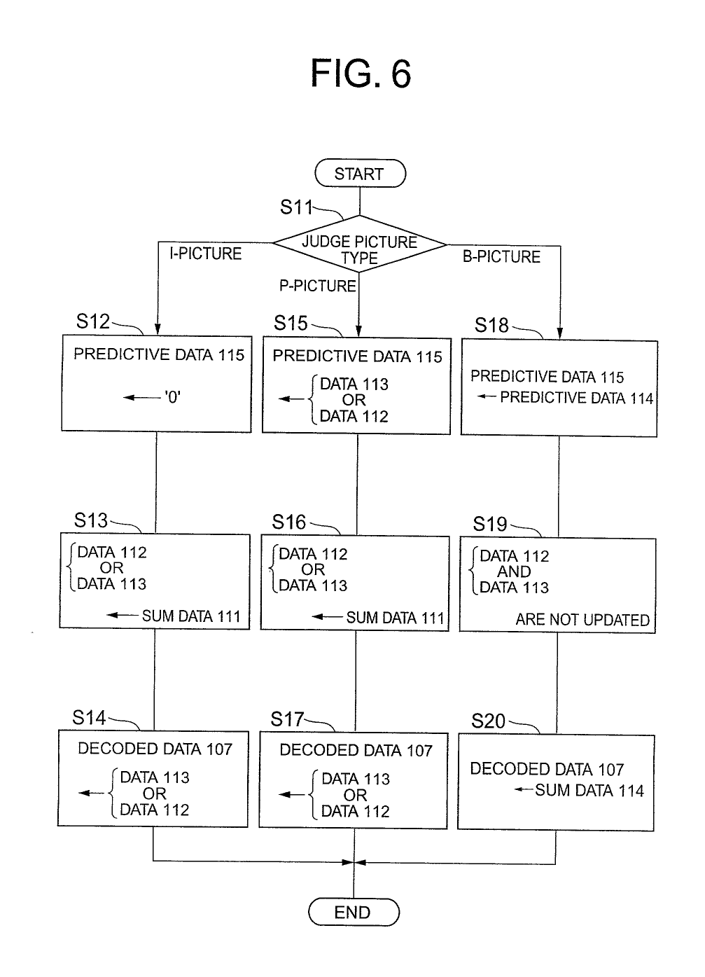

Referring to FIG. 6, the moving-picture data reproducing system of the present embodiment operates for normal picture display when the reduction display signal 106 assumes a low level. In the normal picture display, the picture-selection control section 28 judges the picture type of frame pictures based on the header information of the frame picture data in the reproduced data 103 (step S11).

If it is judged in step S11 that the frame picture is I-picture, the second selector 26 couples the output terminal 225 to the input terminal 224, whereby the predictive data 115 is set at “0”. Thus, the adder 21 adds the addend “0” to the reproduced data 103, thereby delivering the reproduced data 103 as it is to the output thereof as decoded data (step S12).

The first selector 22 selects either the first storage data 112 or the second storage data 113 which is updated earlier, by coupling the input terminal 211 to the selected output terminal 212 or 213. The thus selected first prediction memory 23 or second prediction memory 24 stores the sum data 111. The selected first storage data 112 or second storage data 113 is updated by the sum data 111.

The third selector 27 selects either the second storage data 113 or the first storage data which is not updated in step S13, by coupling the selected input terminal 233 or 232 to the output terminal 234. The selected second storage data 113 or first storage data 112 is selected as the decoded data 107 (step S14), thereby ending the process.

If it is judged in step S11 that the frame picture is P-picture, the second selector 26 selects either the second storage data 113 or first storage data 112 which is updated earlier, by coupling the selected input terminal 223 or 221 to the output terminal 225. The predictive data 115 is set at the selected second storage data 113 or first storage data 112. The adder 21 adds the selected storage data 113 or 112 as an addend to the reproduced data 103, thereby decoding the reproduced data 103 to generate sum data 111 (step S15).

The procedures in steps S16 and S17 are similar to those in steps S13 and 14, and thus the description thereof is omitted herein.

If it is judged in step S11 that the frame picture is a B-picture, the second selector selects the average data 114, by coupling the input terminal 222 to the output terminal 225. Thus, the predictive data 115 is set at the average data 114. The adder 21 adds the average data as an addend to the reproduced data 103, thereby decoding the reproduced data 103 as a sum data 111 (step S18)

In this case, the first selector 22 couples the input terminal 211 to the output terminal 214 so that the first storage data 112 and the second storage data 113 are not updated (step S19).

The third selector 27 selects the sum data 11 as a decoded data 107 by coupling the input terminal 231 to the output terminal 234 (step S20), thereby ending the process shown in FIG. 6.

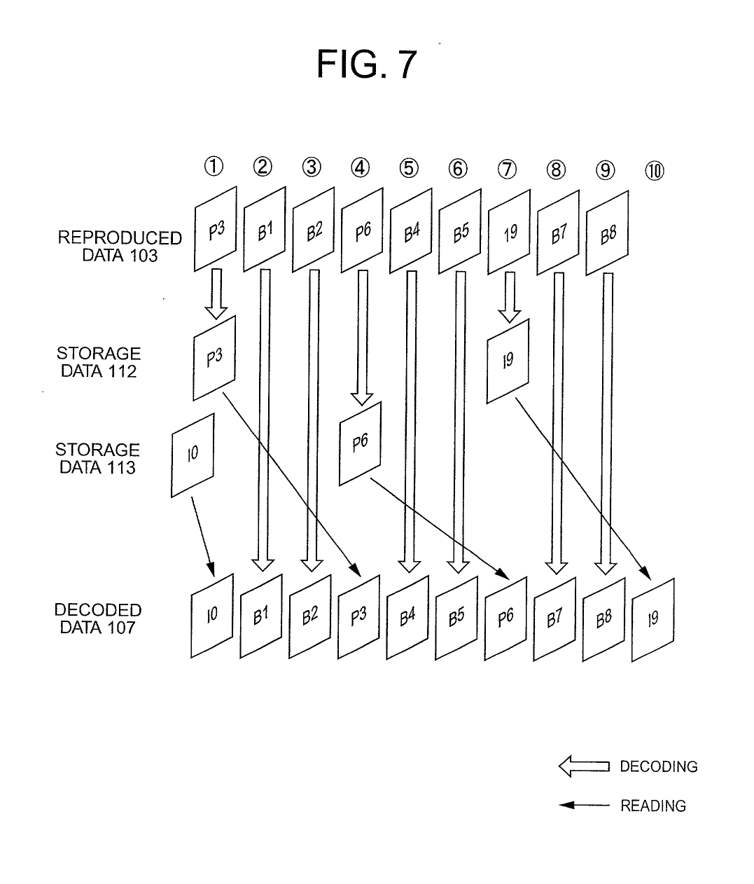

Referring to FIG. 7, there are exemplified ten frame picture data displayed in a normal picture display operation using the procedures shown in FIG. 6. The reproduced data 103 includes consecutively frame pictures P3 (P-picture), B1 (B-picture), B2 (B-picture), P6 (P-picture), B4 (B-picture), B5 (B-picture), 19 (I-picture), B7 (B-picture), and B8 (B-picture), as shown in FIG. 7, and are subjected to processing by the process of FIG. 6. It is assumed that the second storage data 113 is updated at 10 (I-picture) after the updating of the first storage data 112.

In the first frame, picture P3 in the reproduced data 103 is decoded, and the first storage data 112 is updated by picture P3. In this frame, the picture I0 stored as the second storage data 113 is selected as the decoded data 107 and delivered to the encoder 14.

In the second and third frames, pictures B1 and B2 in the reproduced data 103 are both decoded, whereby pictures B1 and B2 are selected as the decoded data 107 in these frames, and delivered to the encoder 14.

In the fourth frame, picture P6 in the reproduced data 103 is decoded, and the second storage data 113 is updated by picture P6. In this frame, picture P3 is selected as the decoded data 107, and delivered to the encoder 14.

In the fifth and sixth frames, pictures B4 and B5 in the reproduced data 103 are respectively decoded, selected as the decoded data 107 in these frames, and delivered to the encoder 14.

In the seventh frame, picture 19 in the reproduced data 103 is decoded, and the first storage data 112 is updated by picture I9. In this frame, picture P6 stored as the second storage data 113 is selected as the decoded data 107, and delivered to the encoder 14.

In the eighth and ninth frames, pictures B7 and B8 are respectively decoded, selected as the decoded data 107 in these frames, and delivered to the encoder 14.

In the tenth frame, frame data is not delivered, and picture I9 stored as the first storage data 112 is selected as the decoded data, and delivered to the encoder 14.

It is to be noted that once the first or second storage data 112 or 113 which is updated earlier is read out from the corresponding prediction memory, the first or second storage data 112 or 113 is updated by the next data.

By iterating the procedures shown in FIG. 6, the moving-picture data reproducing system 10 of the present embodiment delivers normal moving-picture data while controlling the decoding operation and the order of pictures to be displayed. Thus, excellent moving pictures having continuous and smooth motions can be reproduced.

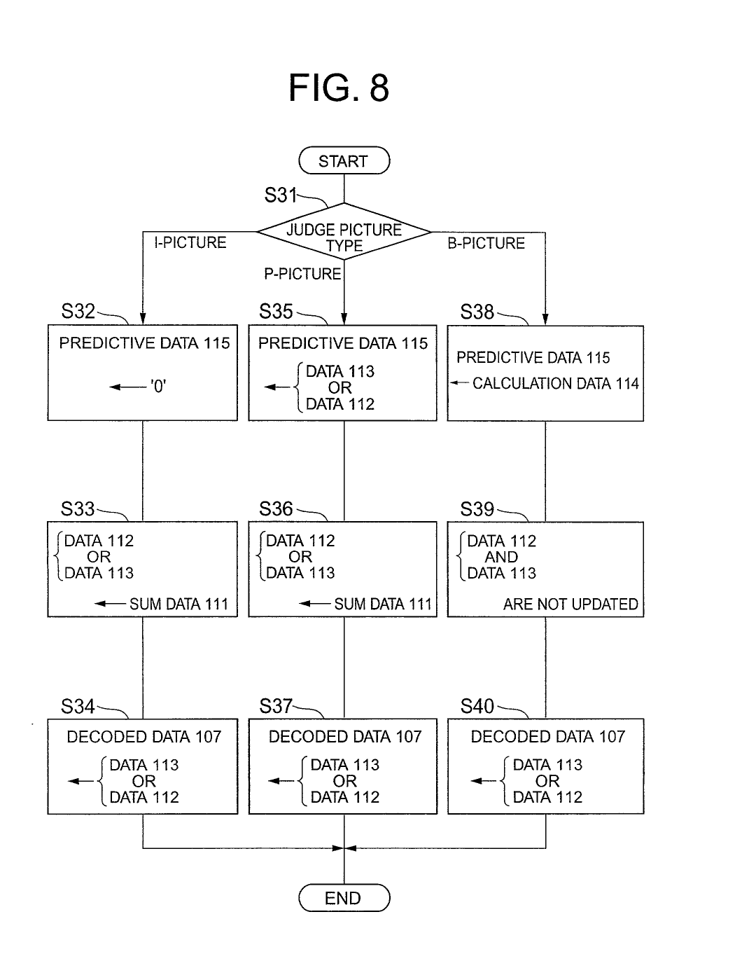

Referring to FIG. 8, the moving-picture data reproducing system 10 of the present embodiment operates for reduced picture display when the reduction display signal 106 assumes a high level. In the reduced picture display, steps S31 to S39 shown in FIG. 8 are similar to steps S11 to S19 shown in FIG. 6, whereas step S40 is different from step S20 shown in FIG. 6.

More specifically, if it is judged in step S31 that the frame picture is a B-picture, the third selector 27 selects either the second storage data 113 or the first storage data 112 which is updated earlier, in step S40. The selected storage data 113 or 112 is selected as the decoded data 107 instead of the B-picture, ending the procedures shown in FIG. 8.

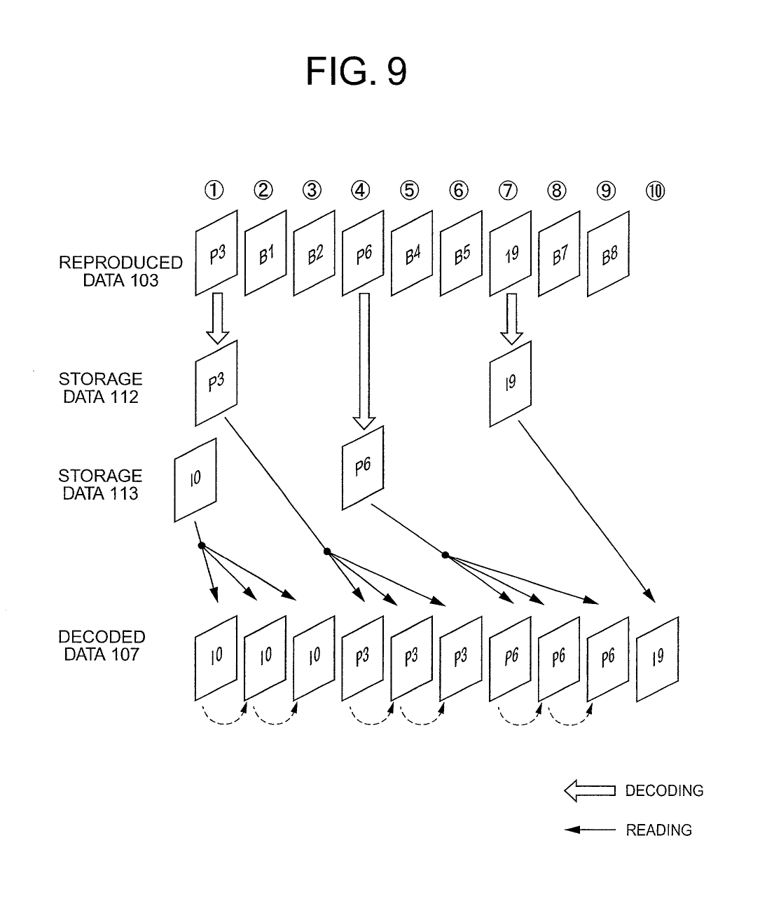

Referring to FIG. 9, the fame data in the reproduced data 103, which are similar to those in FIG. 7, are displayed by a reduced picture display using the procedures shown in FIG. 8. The procedures in the first, fourth, seventh and tenth frames are similar to those shown in FIG. 7, whereas the procedures in the other frames are different from those shown in FIG. 7.

More specifically, in the first frame, frame picture P3 is decoded and stored as the first storage data 112, and picture 10 stored as the second storage data 113 is selected as the decoded data 107. In the second and third frames, pictures B1 and B2 in the reproduced data 103 are both removed or omitted, then picture 10 stored as the second storage data 113 is iteratively selected as the decoded data 107 instead of pictures B1 and B2, and delivered to the encoder 14. In the fourth frame, picture P6 is decoded, and stored as the second storage data 113. Picture P3 stored as the first storage data 112 is selected as the decoded data 107, and delivered to the encoder 14.

In the fifth and sixth frames, pictures B4 and B5 in the reproduced data 103 are both removed, and picture P3 stored as the first storage data 112 is iteratively selected as the decoded data 107 instead of pictures B1 and B2, and delivered to the encoder 14. In the seventh frame, picture 19 is decoded and stored as the first storage data 112, and picture P6 stored as the second storage data 113 is selected as the decoded data 107, and delivered to the encoder 14.

In the eighth and ninth frames, pictures B7 and B8 are removed, and picture P6 stored as the second storage data 113 is iteratively selected as the decoded data 107 instead of pictures B7 and BS, and delivered to the encoder 14. In the tenth frame, picture 19 stored as the first storage data 112 is selected as the decoded data 107, and delivered to the encoder 14.

By iterating the procedures shown in FIG. 8, the moving-picture data reproducing system 10 of the present embodiment delivers reduced picture data while controlling the decoding operation and the order of frame pictures to be displayed. In this operation, the preceding picture is displayed for three times instead of the current frame picture data. Thus, incomplete moving pictures having unsmooth motions are displayed on the screen of the reproducing system.

In a conventional fast-forward reproduction, a part of sequential picture data is generally removed at a constant interval, with the remaining part of the sequential picture data being reproduced consecutively. In this case, since the time length for the reproduction is reduced compared to the time length consumed for reproducing the original picture data, a marginal time length is inserted in the reproduction. Thus, a timer is generally used for measuring the constant time interval and/or the marginal time length.

On the other hand, in the reduced picture display effected by the moving-picture data reproducing system of the present embodiment, by removing a specified part of the sequential picture data and inserting the stored part of the remaining sequential picture data instead of the removed part, the time length for the picture display is made equal to the time length for the original picture data. In this configuration, the reduced picture display of the unsmooth moving-picture does not necessitate the use of timer.

According to the moving-picture data reproducing system of the present embodiment, the unsmooth moving-picture observed as a visual picture at each shot urges the user to subscribe to the content service.

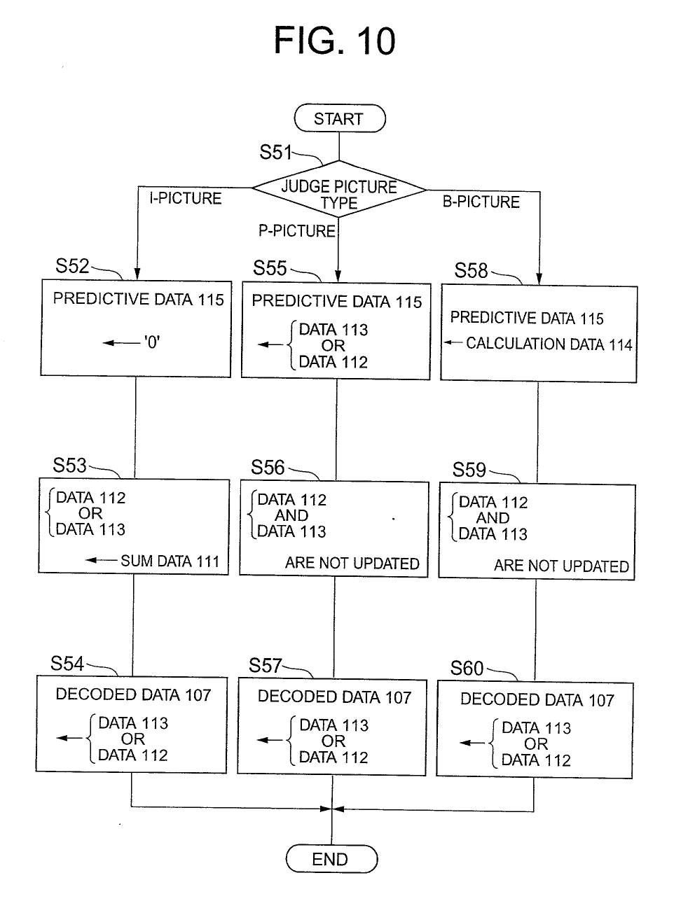

Referring to FIG. 10, the moving-picture data reproducing system according to a second embodiment of the present invention uses I-pictures instead of B- and P-pictures in the reduced picture display. In the reduced picture display, steps S51 to S55 shown in FIG. 10 are similar to steps S31 to S35 shown in FIG. 8.

If it is judged in step S51 that the frame picture is a P-picture, the first selector 22 selects either the second storage data 113 or the first storage data 112 (step S55). In this case, both the storage data are not updated in step S56.

Steps S57 to S60 are similar to steps S37 to S40 shown in FIG. 8.

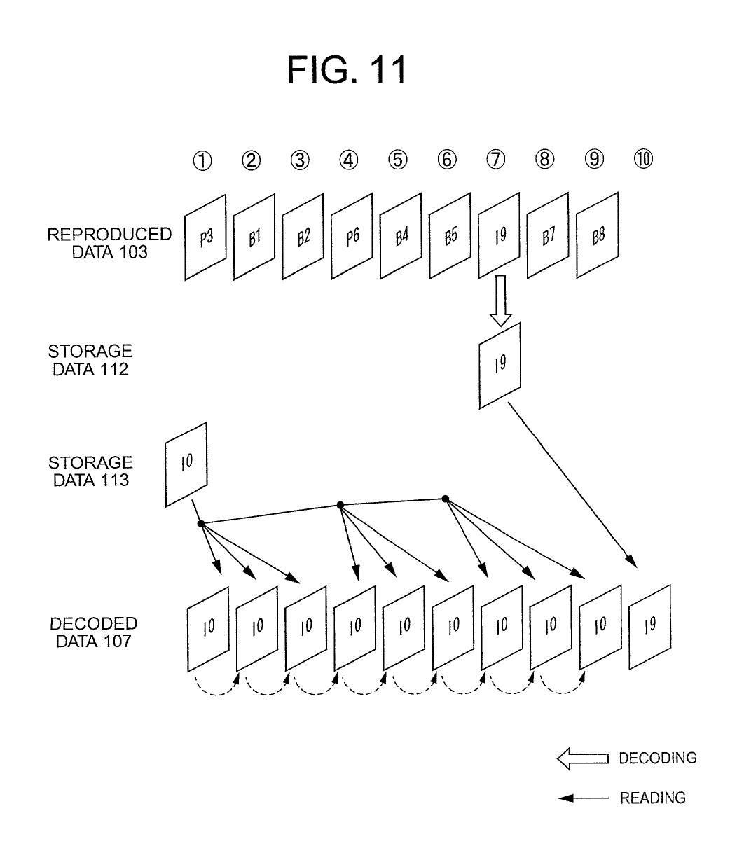

Referring to FIG. 11, the fame data in the reproduced data 103 which are similar to those in FIG. 9 are displayed by a reduced picture display using the procedures shown in FIG. 10. The procedures in the second, third and tenth frames are similar to those shown in FIG. 9, whereas the procedures in the other frames are different from those shown in FIG. 7 in the selection of the decoded data 107.

More specifically, in the first frame, picture P3 in the reproduced data 103 is removed, and picture 10 stored as the second storage data 113 is not updated, selected as the decoded data 107 and delivered to the encoder 14. Picture 10 is also selected in the second to sixth frames as the decoded data 107 instead of the then reproduced pictures B1, B2 . . . , B5 which are removed.

In the seventh frame, picture 19 in the reproduced data 103 is decoded and stored as the first storage data 112, and picture I0 is again selected as the decoded data. In the eighth and ninth frames, pictures B7 and B8 are removed, and picture I0 stored as the second storage data 113 is selected as the decoded data 107, and delivered to the encoder 14. In the tenth frame, picture I9 is selected as the decoded data 107, and delivered to the encoder 14.

By iterating the procedures shown in FIG. 10, the moving-picture data reproducing system of the present embodiment delivers reduced picture data while controlling the decoding operation and the order of frame pictures to be displayed. In this operation, the preceding picture is displayed for a number of times instead of the frame picture data. Thus, incomplete moving pictures having unsmooth motions can be reproduced.

Since the above embodiments are described only for examples, the present invention is not limited to the above embodiments and various modifications or alterations can be easily made therefrom by those skilled in the art without departing from the scope of the present invention.

What is claimed is:

1. A moving-picture data reproducing system for reproducing compressed moving-picture data including I-pictures, P-pictures and B-pictures, said reproducing system comprising:
a toll judgement section for judging whether or not the compressed moving picture data includes toll information;
a qualification judgement section for judging whether a user is qualified or unqualified for reproduction of the compressed picture data; and
a decoder for decoding the I-pictures, P-pictures and B-pictures if it is judged that the compressed picture data do not include toll information or it is judged that the user is qualified, said decoder decoding I-pictures or I- and P-pictures without decoding the B- and P-pictures or without decoding the B-pictures if it is judged that the compressed data includes the toll information and that the user is unqualified.

2. The moving-picture data reproducing system as defined in claim 1, wherein the toll information is electronic watermark data distributed in the compressed picture data.

3. The moving-picture data reproducing system as defined in claim 1, wherein said decoder comprises a reduction judgment section for generating a reduction picture signal based on results of judgement by said toll judgement section and said qualification judgement section.

4. The moving-picture data reproducing system as defined in claim 3, wherein said decoder comprises a picture type judgement section for judging whether the picture in the compressed moving-picture data is an I-, P- or B-picture, said decoder delivering preceding I-pictures instead of decoding B- and P-pictures upon generation of said reduction picture signal.

5. The moving-picture data reproducing system as defined in claim 3, wherein said decoder comprises a picture type judgement section for judging whether the picture in the compressed moving-picture data is an I-, P- or B-picture, said decoder delivering preceding I- or P-pictures instead of decoding B-pictures upon generation of said reduction picture signal.

6. A method for reproducing compressed moving-picture data including I-pictures, P-pictures and B-pictures, said method comprising the steps of:
judging whether or not the compressed moving-picture data includes toll information;
judging whether a user is qualified or unqualified for reproduction of the compressed moving-picture data; and
decoding the I-pictures, P-pictures and B-pictures, if it is judged that the compressed moving-picture data do not include toll information or it is judged that the user is qualified, and decoding the I-pictures or the I- and P-pictures if it is judged that the compressed data includes the toll information and that the user is unqualified.

7. The method as defined in claim 6, wherein said decoding step comprises the steps of judging whether the picture in the compressed moving-picture data is an I-, P- or B-picture, and delivering preceding I-pictures instead of decoding B- and P-pictures, depending on results of judgements by said judgement steps.

8. The method as defined in claim 6, wherein said decoding step comprises the steps of judging whether the picture in the compressed moving-picture data is an I-, P- or B-picture, and delivering preceding I- or P-pictures instead of decoding B-pictures, depending on results of judgements by said judgement steps.
